(19) United States
(12) Patent Application Publication
(10) Pub. No.: US 2025/0322223 A1
(43) Pub. Date: Oct. 16, 2025

(54) METHOD AND SYSTEM FOR DATA COMPRESSION USING STATE SPACE NEURAL NETWORKS

(71) Applicant: APPLIED BRAIN RESEARCH INC., Waterloo (CA)

(72) Inventor: Christopher David ELIASMITH, Waterloo (CA)

(21) Appl. No.: 19/178,405

(22) Filed: Apr. 14, 2025

Related U.S. Application Data
(60) Provisional application No. 63/633,668, filed on Apr. 12, 2024.

(51) Int. Cl. G06N 3/0495; G06N 3/0455

(52) U.S. Cl. CPC G06N 3/0495; G06N 3/0455

(57) ABSTRACT

A method and system for compressing and decompressing digital data employs a codec comprising state space neural network (SSNN) layers. The encoder comprises one or more SSNN layers; when a plurality of SSNN layers are used, they may be arranged with decreasing dimensionality. The decoder also comprises one or more SSNN layers, and when a plurality of SSNN layers are used, they may be arranged with increasing dimensionality. The method and system may also include quantization of compressed data, and additional pre- and post-processing of input and output data. The quantizer may also comprise SSNN layers. The codec and quantizer may be optimized together or separately, for example using a loss metric.

### CROSS-REFERENCE TO RELATED APPLICATIONS

This application claims priority from U.S. Provisional Application No. 63/633,668, filed Apr. 12, 2024, the entirety of which is incorporated herein by reference.

### TECHNICAL FIELD

The present disclosure relates to data compression and, more particularly, to methods and systems for compressing data.

### TECHNICAL BACKGROUND

Data compression techniques traditionally rely on statistical and algorithmic methods to reduce the memory required to represent data, facilitating efficient storage and transmission. Classical lossless compression methods, such as Huffman coding and the Lempel-Ziv-Welch (LZW) algorithm, leverage redundancy to achieve compression without loss of information. Lossy compression techniques, such as JPEG and MPEG, exploit human perceptual limitations to remove less critical data, achieving higher compression ratios.

With the exponential increase in data generation from Internet of Things (IoT) and mobile devices, existing compression approaches encounter significant challenges in terms of adaptability and efficiency. Standard data compression techniques are often good for one form of data, but not another. Recent advances in neural networks have demonstrated improved pattern recognition and encoding capabilities, but traditional deep learning models impose computational and power constraints unsuitable for edge devices.

Standard signal processing approaches to building compression codecs often result from hand-designed compressors that are highly dependent on the designer's understanding of the domain being compressed (e.g., images, audio signals). These approaches have resulted in solutions like the MP3 codec for audio signal storage and Opus for real-time communication. Given the power of neural networks to automatically discover regularities in audio signals, they have recently been used to aid in the design of an effective audio codec (Zeghidour, N, A Luebs, A Omran, J Skoglund, M Tagliasacchi. “Soundstream: An end-to-end neural audio codec”, IEEE/ACM Transactions on Audio, Speech, and Language Processing, 2021). In many cases, these data-driven techniques outperform traditional codecs.

The methods and systems described in the aforementioned references and many similar references assume significant domain knowledge, feedforward convolutional neural networks, or nonlinear network layers in their design. The restricted set of neural architectures results in particular assumptions being built into the codecs being designed using these methods. In addition, these architectures are computationally expensive and do not run efficiently on hardware built to run recurrent neural networks.

### BRIEF DESCRIPTION OF THE DRAWINGS

In drawings which illustrate by way of example only embodiments of the present invention,

FIG. 1 is a diagram of an example state space neural network (SSNN) layer that may be employed in an SSNN-based encoder, decoder, or codec.

FIG. 2 is a diagram of an example system implementing a SSNN-based codec employing the SSNN layer of FIG. 1.

### DETAILED DESCRIPTION

The present disclosure provides methods and systems that integrate state space neural networks (SSNNs) into data-driven compression codecs. SSNNs offer an efficient approach to time series data representation; see for example commonly-owned United States Patent Application Publications No. 2022/0172053 and 2023/0359861, and U.S. patent Ser. No. 11/238,345, all of which are incorporated herein by reference. By leveraging mathematical methods from state space modeling, SSNNs achieve efficient representation of time series data while reducing computational overhead.

The integration of SSNNs in the design of data-driven compression codecs addresses the concerns and shortcomings identified above. SSNNs have both recurrent and feedforward implementations, with recurrent implementations being particularly efficient in edge use cases. SSNNs mix linear and nonlinear network layers to improve the performance of time series data representation, especially in a streaming context. As well, SSNNs are more computationally efficient as a function of the window length than other network layers, which is beneficial for improving the quality of data representation. SSNNs have also been shown to require less data for the same level of optimized performance on a variety of applications. In summary, SSNNs effectively model data temporal structures, achieving higher efficiency and better compression ratios; learn tailored representations for different data types; and have reduced parameter count and computational complexity for deployment on low-power devices, particularly those designed to efficiently run recurrent networks.

In the example implementation discussed below, a computing system comprises a codec (encoder and decoder) implemented using SSNNs, where the encoder processes input data through a structure of state space models to efficiently generate a compressed representation of the input data, and the decoder reconstructs the original data from the compressed representation with minimal loss of fidelity. The system optionally integrates a trainable vector quantization mechanism for efficient encoding.

By leveraging the properties of SSNNs, each of the encoder and decoder achieve superior performance compared to conventional neural network-based approaches while maintaining or improving computational efficiency. This is particularly advantageous for time-series data, real-time streaming applications (in particular multimedia, which generally requires efficient video and audio codecs), and environments with limited bandwidth, storage and/or computing resources, such as mobile and IoT edge applications. It is most advantageous for purpose built SSNN hardware accelerators. Further, the embodiments discussed below are useful for a wide variety of data types including text, images, biosignals, audio, and video, and in applications including, but not limited to, wearables, wireless communication, autonomous systems, special purpose imaging (e.g., medical, satellite), and cloud storage. The data-driven nature of the solution and the data efficiency in training SSNNs makes the codecs particularly easy to tailor to very specific applications and suited to low-data availability applications. The outputs from such codecs are more computationally efficient, consider longer temporal windows, and improve compression ratios compared to current techniques.

The codec may be tailored to specific datasets by training it on sample data that is representative of the data to be compressed. For instance, for a biosignal compressor, the system would be trained on data specific to that biosignal (and/or sensor), e.g., heart beats, blood oxygen levels, glucose levels, breathing rates, and so on. After training, the codec, i.e., encoder and decoder, can be used in “inference” mode. Typically, the inference model is the final codec that targets special purpose hardware for running SSNNs.

The SSNN-based encoder and decoder each comprise at least one SSNN layer. Each SSNN layer implements a linear time-invariant (LTI) dynamical system in a linear layer, followed by a nonlinear layer comprising nodes with nonlinear activation functions. The LTI may be implemented as a recurrent connection or feedforward layer. The encoder and decoder may optionally include additional, non-SSNN network layers. Responses are computed to eventually generate either (a) output predictions, or (b) a loss metric, in which case the loss is backpropagated through each SSNN layer with its input sequence so as to calculate parameter gradients across all layer inputs. These parameter gradients are used to update the network's weights so as to minimize the loss metric.

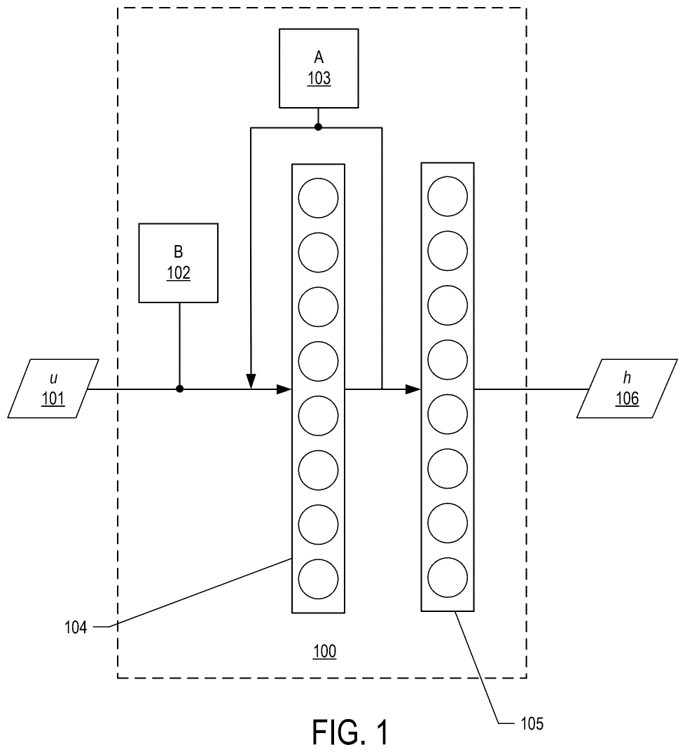

An example SSNN layer architecture 100 that may be employed in both the encoder and decoder portions of the code is shown in FIG. 1. The SSNN layer 100 takes an input vector u 101, projected through an input matrix B 102 comprising fixed or learnable weights. The resulting state in the linear layer 104 captures information over a previous window of time for a time series of vector inputs. This state is updated through a dynamics matrix A 103 so as to update the state in light of the current input to continue to represent the input time series history in a manner appropriate to the current application. The linear layer 104 implements the dynamical system given by:

$$\dot{x} = A x + B u$$

where x is the state in the linear layer 104, A is the dynamics matrix 103, B is the input matrix 102, and u is the vector input 101. This differential equation can be discretized using various techniques (e.g., zero-order hold, Euler, Runge-Kutta, etc.) for implementation on special purpose and digital hardware, or implemented using an impulse response.

The output of the linear layer 104 is input to a nonlinear layer 105 comprising nodes with nonlinear activation functions that further process the state to generate an output 106 as given by:

$$h = σ ( W x + b )$$

where h is the output of the nonlinear layer 105, σ is the activation function, W is a matrix of layer parameters, x is the output of the linear layer, and b are bias parameters. In some embodiments, there may be additional recurrent connections on the nonlinear layer 105, or from the nonlinear layer 105 to the linear layer 104. However, these tend to be more difficult to optimize and may not provide better performance than the illustrated example.

The use of SSNN layers 100 does not preclude the use of additional layer types in the encoder or decoder, such as attention layers, convolutional layers, or the use of architectural elements like skip connections. Such additional layers may be interleaved with the SSNN layers. SSNNs are ideally suited to compression, and it has been shown that SSNNs provide optimal time series representations of streaming data (Aaron R. Voelker. Dynamical Systems in Spiking Neuromorphic Hardware. PhD thesis, University of Waterloo, 2019).

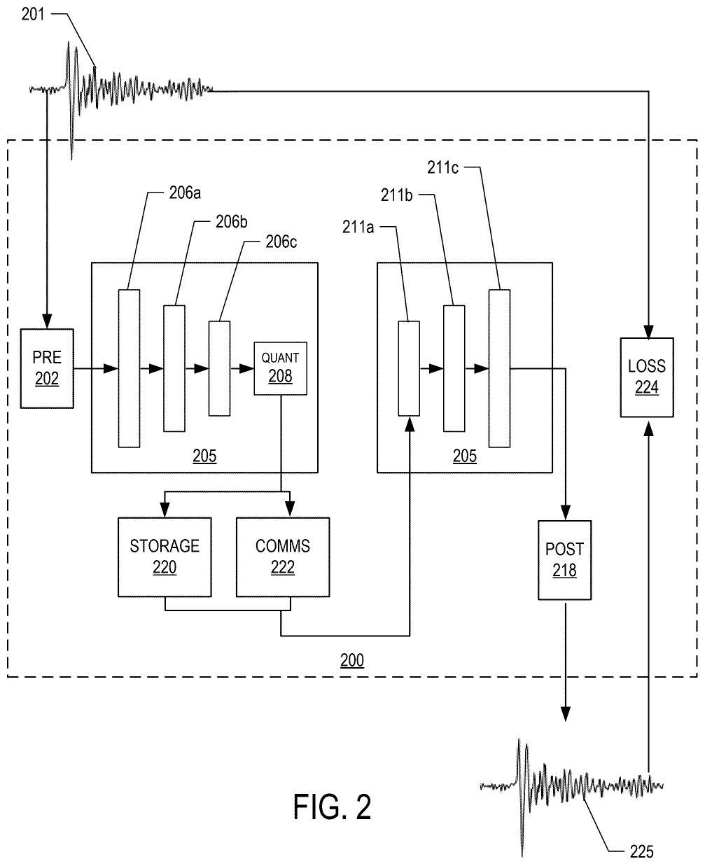

FIG. 2 depicts an exemplary system 200 implementing a SSNN-based codec. An input signal 201 is received by the system 200 and, if necessary, is preprocessed by a preprocessing module 202. Preprocessing may include various kinds of filtering, such as low or high-pass, or generation of other feature representations, such as discrete cosine transforms (DCT) or Mel-frequency cepstral coefficients (MFCCs) The input signal 201, optionally preprocessed, is then fed into an encoder module 205 that comprising one or more SSNN layers such as those shown in FIG. 1. In the example implementation of FIG. 2, the encoder 205 comprises three SSNN layers 206a, 206b, and 206c, but fewer or more layers may be employed. The SSNN layers 206a, 206b, 206c may be stacked in a hierarchical arrangement, such that lower layers typically capture local dependencies and higher layers learn global representations. The SSNN layers would thus be arranged with decreasing dimensionality. The state transition dynamics of SSNNs optimize data encoding by preserving temporal coherence and reducing redundancy.

The output of the encoder module 205 is thus a compressed latent representation of the input signal 201. The compressed representation is then optionally quantized using a vector quantizer 208. While quantization of the output of the encoder module is not absolutely necessary, those skilled in the art recognize that this is often advantageous in further reducing the size of the compressed representation. As will be appreciated by those skilled in the art, the quantizer 208 may be learned; that is to say, it can be trained alongside the SSNN encoder to discretize the compressed latent representation, further reducing data size while maintaining accuracy. The resulting compressed representation can then be efficiently stored in a memory or storage device 220 of the system 200, and/or transmitted via a communications system 222 to a recipient.

Reconstructing the compressed representation of the input signal is performed by a decoder 210. Like the encoder 205, the decoder 210 is comprised of one or more SSNN layers 211a, 211b, 211c, such as the SSNN layer depicted in FIG. 1. The SSNN layers 211, 211b, 211c may be stacked in a hierarchical arrangement, this time with increasing dimensionality complementing the SSNN structure of the encoder 205, thus reversing the compression. The compressed representation (received, for example, via the communications system 222 or retrieved from memory or storage 220) is fed through the SSNN layers of the decoder 210 to produce a reconstruction 225 of the input data. An optional postprocessing module 218 is provided for any desired postprocessing, such as a low-pass filter, to adjust the final output and improve performance. The use of SSNNs ensures that key features of the original data are preserved with minimal loss, which is especially useful for streaming time series data.

While FIG. 2 depicts the encoder 205, decoder 210, and communications system 222 as discrete modules or subsystems within the system 200, in some implementations the encoder 205 and/or decoder 210 may be integrated with the communications system 222. For example, the encoder 205 may be comprised in a transmitter module of the communications system 222, while the decoder 210 may be comprised in a receiver module. Those skilled in the art will also appreciate that while a system 200 may typically be configured to both encode and decode signals, in some implementations the encoder 205 and 210 may be provided in discrete systems, which would allow for particularly efficient execution on special purpose hardware designed to execute SSNNs.

The entire codec (encoder and decoder 205, 210) may be optimized. In the system 200 illustrated in FIG. 2, a loss function module 224 takes as input signal 201 and the reconstructed output signal 225 and executes a loss function to compute a loss metric. The resultant loss metric can then be used to determine how to change the network parameters of the SSNN layers in the encoder 205 and/or decoder 210, in accordance with standard deep learning techniques. The loss function executed by the loss function module 224 may comprise another neural network (often called a discriminator network). The loss function module 224 is not required during inference, and may be omitted from the system 200 if optimization is not carried out in the system 200 or in the individual transmitter or receiver modules comprising the encoder 205 and decoder 210.

The implementation of the SSNN-based compression system may involve hardware accelerators such as GPUs or TPUs for training, while inference can be optimized for CPU or specialized edge AI hardware. Components of the system 200 may be implemented using a variety of standard techniques such as by using microcontrollers or ASICs. Nonlinear components may be implemented using a combination of adaptive and non-adaptive components. Examples of nonlinear components that can be used in various embodiments described herein include simulated/artificial neurons, configurable hardware such as FPGAs, GPUs, and other parallel computing systems. In addition, nonlinear components may be implemented in various forms including software simulations, hardware, or any neuronal fabric. Nonlinear components may also be implemented using neuromorphic computing devices such as Neurogrid, SpiNNaker, Loihi, and TrueNorth. The examples discussed will be particularly advantageous on purpose-built SSNN hardware. The system can be embedded into existing compression pipelines or deployed as a standalone solution. Purpose-built SSNN hardware may include recurrent linear layer support and nonlinear layer support, which allows for an efficient implementation of the proposed compressor, as the key computations are natively supported.

“Node”, in the context of an artificial neural network, refers to a basic processing element that implements the functionality of a simulated “neuron”, which may be a spiking neuron, a continuous rate neuron, or an arbitrary linear or non-linear component used to make up a distributed system.

A “recurrent connection” refers to a set of weighted connections that transfer the output of one or more nodes in a given network layer back as input to one or more nodes in the same or an earlier layer.

The term “activation function” here refers to any method or algorithm for applying a linear or nonlinear transformation to some input value to produce an output value in an artificial neural network. Examples of activation functions include the identity, rectified linear, leaky rectified linear, thresholded rectified linear, parametric rectified linear, sigmoid, tanh, softmax, log softmax, max pool, polynomial, sine, gamma, soft sign, heaviside, swish, exponential linear, scaled exponential linear, and gaussian error linear functions.

Activation functions may optionally output “spikes” (i.e., one-bit events), “multi-valued spikes” (i.e., multi-bit events with fixed or floating bit-widths), continuous quantities (i.e., floating-point values with some level of precision determined by the given computing system—typically 16, 32, or 64-bits), or complex values (i.e., a pair of floating point numbers representing rectangular or polar coordinates). These aforementioned functions are commonly referred to, by those of ordinary skill in the art, as “spiking”, “multi-bit spiking”, “non-spiking”, and “complex-valued” neurons, respectively. When using spiking neurons, real and complex values may also be represented by one of any number of encoding and decoding schemes involving the relative timing of spikes, the frequency of spiking, and the phase of spiking. However, it will be understood by those of ordinary skill in the art that the embodiments described herein may be practiced without these specific details.

The term “linear network layer” or “linear layer” here refers to any layer in an artificial neural network that computes its output values using a linear activation function such as the identity function.

The term ‘dynamical system’ here refers to any system in which the system state can be characterized using a collection of numbers corresponding to a point in a geometrical space, and in which a function is defined that relates this system state to its own derivative with respect to time. In other words, a dynamical system comprises a state space along with a function that defines transitions between states over time. The term “linear time-invariant dynamical system” refers to a specific class of dynamical system for which the relationship between the system's input at a given time and its output is a linear mapping; moreover, this mapping is time invariant in the sense that a given input will be mapped to the same output regardless of the time at which the input is applied. LTI systems have the advantage of being relatively easy to analyze mathematically in comparison to more complex, nonlinear systems.

The term ‘loss metric’ here refers to a scalar output value that is to be minimized by the computations of an artificial neural network. Examples of loss metrics include mean-squared error (MSE), cross-entropy loss (categorical or binary), Kullback-Leibler divergence, cosine similarity, and hinge loss. A loss metric is computed using a loss function that produces the metric from one or more inputs; these inputs may consist of externally supplied data, outputs computed by nodes in an artificial neural network, supervisory and reward signals, the state of a dynamical system, or any combination thereof. Loss functions may be implemented by other artificial neural networks by comparing the original and reconstructed signals in the case of data compression.

There is thus provided a computer-implemented method for compressing digital data, the method comprising receiving, by at least one processor of a computer system, input data; generating, by the at least one processor executing a state space neural network (SSNN)-based encoder comprising at least one SSNN layer, a compressed representation of the input data; and storing the compressed representation in a memory or storage device, and/or transmitting the compressed representation to a recipient.

There is also provided a computer-implemented method for decompressing digital data, the method comprising receiving, by at least one processor of a computer system, a compressed representation of data; generating, by the at least one processor executing a state space neural network (SSNN)-based decoder comprising at least one SSNN layer, a reconstructed version of the data; and storing the reconstructed version of the data in a memory or storage device.

In one aspect, the input data comprises time series or streaming data.

In another aspect, the at least one SSNN layer comprises a recurrently-connected linear layer and a nonlinear layer, wherein output of the linear layer is provided as input to the nonlinear layer. In some implementations, the SSNN-based encoder comprises a plurality of SSNN layers arranged with decreasing dimensionality. Further, in some implementations, the SSNN-based decoder comprises a plurality of SSNN layers arranged with increasing dimensionality.

In another aspect, the compression method further comprises the at least one processor discretizing the compressed representation by applying a vector quantization to the compressed representation. In some implementations, the SSNN-based encoder comprises a SSNN-based vector quantizer executed by the at least one processor to apply the vector quantization to the compressed representation.

In a further aspect, the at least one processor generates a loss metric using a loss function, using the input data and the reconstructed version of the data, to optimize parameters of the SSNN-based encoder and/or decoder based on the loss metric thus generated, and in particular the SSNN-based encoder and decoder together.

In still a further aspect, parameters of the vector quantizer are optimized concurrently with those of the SSNN-based encoder and/or decoder.

In another aspect, there is provided a system for compressing and/or decompressing digital data, comprising at least one processor configured to execute the methods described above.

In one aspect, the system comprises a preprocessing module for formatting received input data for processing by the state space neural network (SSNN)-based encoder.

In another aspect, the system comprises a postprocessing module for further processing data decompressed by the system.

In a further aspect, the system includes a vector quantizer for discretizing the compressed representation prior to storage or transmission. In still another aspect, the vector quantizer comprises a SSNN-based vector quantizer.

In yet another aspect, the system also comprises a loss function module, wherein the at least one processor is configured to execute the loss function module to generate a loss metric to optimize parameters of the SSNN-based encoder and/or decoder, and in particular the encoder and decoder together. In a further aspect, parameters of the vector quantizer are optimized together with those of the codec.

It should be understood that this description is not intended to be limiting, and that the examples contemplated herein include all alternatives, modifications, and equivalents as would be appreciated by the person skilled in the art, and are included within the scope of the accompanying claims. Although the features and elements various examples or embodiments may be described as being in particular combinations, the person of ordinary skill in the art will appreciate that individual features or variations described in respect of one example or embodiment in this disclosure can be used alone, or in combination with select other features of other examples or embodiments mentioned herein. Some steps or acts in a process or method may be reordered or omitted as would be appreciated by the person of ordinary skill in the art.

1. A computer-implemented method for compressing digital data, the method comprising:
receiving, by at least one processor of a computer system, input data;
generating, by the at least one processor executing a state space neural network (SSNN)-based encoder comprising at least one SSNN layer, a compressed representation of the input data; and
storing the compressed representation in a memory or storage device, and/or transmitting the compressed representation to a recipient.

2. The computer-implemented method of claim 1, wherein the input data comprises time series or streaming data.

3. The computer-implemented method of claim 1, wherein the at least one SSNN layer comprises a recurrently-connected linear layer and a nonlinear layer, wherein output of the linear layer is provided as input to the nonlinear layer.

4. The computer-implemented method of claim 1, wherein the SSNN-based encoder comprises a plurality of SSNN layers arranged with decreasing dimensionality.

5. The computer-implemented method of claim 1, further comprising the at least one processor discretizing the compressed representation by applying a vector quantization to the compressed representation.

6. The computer-implemented method of claim 5, wherein the SSNN-based encoder comprises a SSNN-based vector quantizer executed by the at least one processor to apply the vector quantization to the compressed representation.

7. The computer-implemented method of claim 1, further comprising the at least one processor decoding the compressed representation to provide a reconstructed version of the input data by executing a SSNN-based decoder, the SSNN-based decoder comprising at least one SSNN layer.

8. The computer-implemented method of claim 7, wherein the SSNN-based decoder comprises a plurality of SSNN layers arranged with increasing dimensionality.

9. The computer-implemented method of claim 7, further comprising the at least one processor generating a loss metric using a loss function using the input data and the reconstructed version of the input data, and optimizing parameters of the SSNN-based encoder and SSNN-based decoder based on the loss metric thus generated.

10. The computer-implemented method of claim 9, further comprising:
the at least one processor discretizing the compressed representation by applying a vector quantization to the compressed representation; and
wherein optimizing the parameters includes optimizing parameters of the vector quantization.

11. A computer-implemented method for decompressing digital data, the method comprising:
receiving, by at least one processor of a computer system, a compressed representation of data;
generating, by the at least one processor executing a state space neural network (SSNN)-based decoder comprising at least one SSNN layer, a reconstructed version of the data; and
storing the reconstructed version of the data in a memory or storage device.

12. The computer-implemented method of claim 11, wherein the at least one SSNN layer comprises a recurrently-connected linear layer and a nonlinear layer, wherein output of the linear layer is provided as input to the nonlinear layer.

13. The computer-implemented method of claim 11, further comprising:
the at least one processor generating a loss metric using a loss function using the reconstructed version of the data and an initial version of the data prior to compression, and optimizing parameters of the SSNN-based decoder and a SSNN-based encoder used to generate the compressed representation based on the loss metric thus generated.

14. A system for compressing digital data, comprising at least one processor configured to execute:
a SSNN-based encoder for generating a compressed representation of input data, the SSNN-based encoder comprising at least one SSNN layer;
a SSNN-based decoder for decoding the compressed representation to provide a reconstructed version of the input data, the SSNN-based decoder comprising at least one SSNN layer;
a memory or storage device for storing the compressed representation, and/or a communication system for transmitting the compressed representation to a recipient.

15. The system of claim 14, further comprising a loss function module, wherein the at least one processor is configured to execute the loss function module to generate a loss metric using the input data and the reconstructed version of the input data, and to optimize parameters of the SSNN-based encoder and decoder based on the loss metric thus generated.

16. The system of claim 15, further comprising a vector quantizer module executed by the at least one processor for discretizing the compressed representation prior to storage or transmission.

17. The system of claim 16, wherein the vector quantizer comprises a SSNN-based vector quantizer.

18. The system of claim 17, wherein the at least one processor is configured to optimize the parameters of the vector quantization module at the same time as the parameters of the SSNN-based encoder and decoder.

19. The system of claim 14, further comprising a preprocessing module for formatting received input data for processing by the state space neural network (SSNN)-based encoder.

20. The system of claim 14, further comprising a postprocessing module executed by the at least one processor for formatting reconstructed version of the input data prior to storage or transmission.
